(19) United States
(12) Patent Application Publication
(10) Pub. No.: US 2021/0327608 A1
(43) Pub. Date: Oct. 21, 2021

(54) COMPOSITE LAYER FOR WRAP STRUCTURE OF TRANSMISSION CABLE

(71) Applicant: James Cheng Lee, La Habra, CA (US)

(72) Inventor: James Cheng Lee, La Habra, CA (US)

(21) Appl. No.: 17/170,910

(22) Filed: Feb. 9, 2021

Related U.S. Application Data
(60) Provisional application No. 63/012,429, filed on Apr. 20, 2020.

(30) Foreign Application Priority Data
Jan. 22, 2021 (CN) 202110086836.8

(51) Int. Cl. H01B 7/02; H01B 1/02

(52) U.S. Cl. CPC H01B 7/0216; H01B 1/02

(57) ABSTRACT

Provided is a composite layer for a transmission cable, covering a conductor of the transmission cable and including an inner wrap layer and a wrap layer. The wrap layer is adhered to the inner wrap layer by a glue material. The inner wrap layer is used for reducing a dielectric constant, and the wrap layer is used for increasing a bending strength of the transmission cable.

### BACKGROUND OF THE INVENTION

### 1. Field of the Invention

The present invention relates to a cable structure, and particularly to a wrap structure of a high speed/frequency transmission cable having a composite layer therein.

### 2. The Prior Arts

In an existing process of manufacturing a transmission cable, an insulation layer is directly pressed on a conductor to achieve the effects of protection and insulation. As shown in FIG. 1, a conductor 10 of a transmission cable 1 is covered with an insulation layer 11. Since a dielectric constant of the insulation layer has a great influence on the performance of high speed/frequency transmission cable, foam materials are usually used to reduce the dielectric constant. However, it is not easy for the foam materials to meet with the standard requirement of distribution and yield in a manufacturing process. Also, an outer diameter of the transmission cable made of the foam material is relatively large, which limits the size selectivity of the transmission cable.

Therefore, the wrapping process is used to improve the above problems. The transmission loss of the cable produced by the wrapping process at high speed/frequency is lower than that by the foaming process. However, the mechanical properties of the wrapped cable, such as bending strength, tensile strength and elongation, are insufficient, and thus it is easy for the wrapped cable to be bent during the cable management and the manufacturing process, which may cause the core to break and reduce the yield.

Therefore, it is needed to provide a cable structure that can improve the bending strength, tensile strength, and elongation.

### SUMMARY OF THE INVENTION

To solve the aforementioned problems, according to an embodiment of the present invention, a composite layer for a transmission cable is provided. The composite layer covers a conductor of the transmission cable and comprises an inner wrap layer and a wrap layer. The inner wrap layer is adhered to the inner wrap layer by a glue material. The inner wrap layer is used for reducing a dielectric constant, and the wrap layer is used for increasing a bending strength of the transmission cable.

In the embodiment, the conductor is made of multiple strands.

In the embodiment, the conductor is made of a metal or an alloy.

In the embodiment, the inner wrap layer is formed of a foam material.

In the embodiment, the wrap layer is composed of an insulation material.

In the embodiment, the inner wrap layer covers the conductor by wrapping.

In the embodiment, the wrap layer surrounds the inner wrap layer by wrapping.

According to another embodiment of the present invention, a wrap structure of a transmission cable is provided. The wrap structure includes a conductor and a composite layer. The composite layer covers the conductor and includes an inner wrap layer and a wrap layer. The wrap layer is adhered to the inner wrap layer by a glue material. The inner wrap layer is used for reducing a dielectric constant, and the wrap layer is used for increasing a bending strength of the transmission cable.

The transmission cable according to the present invention can reduce the dielectric constant by covering the inner wrap layer on the conductor before performing the wrapping process. In addition, the alternating wrap manner for the wrap layer can make the transmission cable more compact during the wrapping process, so that the torsion, bending and stretching strength of the transmission cable can be improved, and its insulation and anti-interference effects can also be improved. In such a way, compared with the prior art, the electrical instability and the mechanical strength of the transmission cable of the present invention can be improved, and the insertion loss can be reduced as well.

Those having ordinary skill in the art will understand that the achieved effects through the disclosure of the present invention are not limited to those specifically described above, and the advantages of the present invention will be more clearly understood from the below detailed description in conjunction with the drawings.

### BRIEF DESCRIPTION OF THE DRAWINGS

FIG. 1 illustrates a transmission cable manufactured by wrap technology of the prior art.

FIG. 2 illustrates a transmission cable according to an embodiment of the present invention.

FIG. 3A illustrates a transmission cable according to another embodiment of the present invention.

FIG. 3B shows a partial structure of the transmission cable of FIG. 3A.

FIG. 4 illustrates a transmission cable based on the embodiment of FIG. 3A.

FIG. 5 illustrates a curve diagram of a time-domain reflectometry measurement according to an embodiment of the present invention.

FIG. 6 illustrates a curve diagram of an insertion loss measurement according to an embodiment of the present invention.

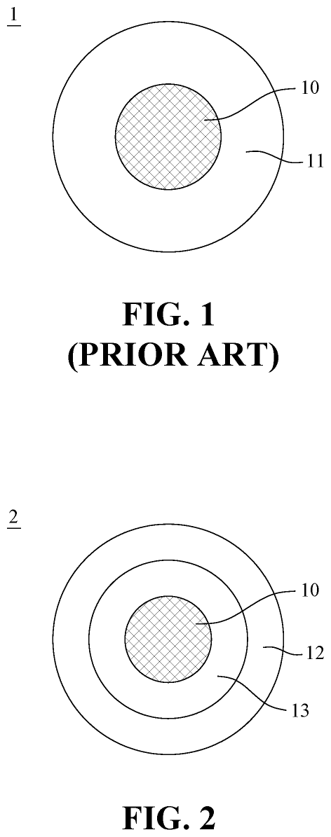

### DETAILED DESCRIPTION OF THE PREFERRED EMBODIMENT

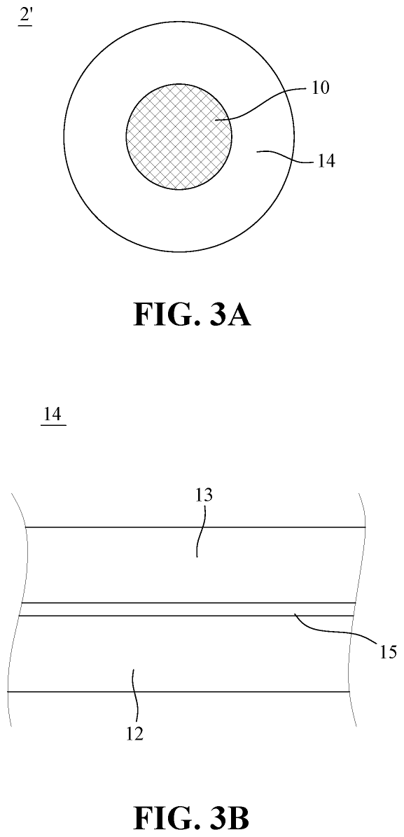

With reference to FIGS. 2, 3A and 3B, FIG. 2 illustrates a transmission cable according to an embodiment of the present invention. The transmission cable 2 sequentially includes a conductor 10, an inner wrap layer 13, and a wrap layer 12 from the inside to the outside. FIG. 3A illustrates a transmission cable 2′ according to another embodiment of the present invention, and FIG. 3B shows a partial structure of the transmission cable 2′ of FIG. 3A. As shown in FIG. 3B, the difference between this embodiment and FIG. 2 is that the wrap layer 12 is adhered to the inner wrap layer 13 by a glue material 15 to form a composite layer 14. In such a way, it only requires one wrapping process of the composite layer 14 to wrap the conductor 10 with the wrap layer 12 and the inner wrap layer 13 to achieve a two-layer protection effect. It should be noted that in the embodiment, the wrap layer 12 and the inner wrap layer 13 are respectively composed of at least two layers of high molecular polymers through the glue material 15.

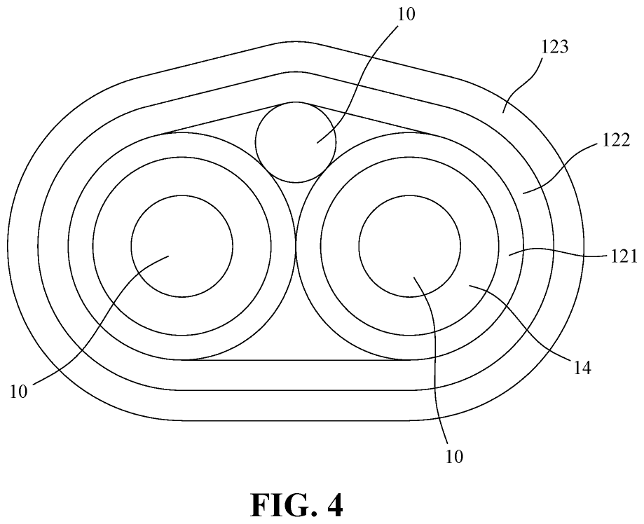

With reference to FIG. 4, FIG. 4 illustrates a transmission cable based on the embodiment of FIG. 3A. As shown in FIG. 4, two cables with the structure of FIG. 3A and a conductor 10 are coated with wrap layers 121, 122, and 123 to form a transmission cable. The wrap layer 121 is mainly composed of the material of the wrap layer 12 mentioned above and covers the composite layer 14 by the glue material 15. Similarly, the wrap layer 122 is composed of the material of the wrap layer 12 mentioned above and covers the wrap layer 121 by the glue material 15, and the wrap layer 123 is composed of the material of the wrap layer 12 mentioned above and covers the wrap layer 122 by the glue material 15. It should be noted that, preferably, the wrap layer 121, which is similar to the wrap layer 12 and the inner wrap layer 13, is also composed of at least two layers of high molecular polymers through the glue material 15. In addition, in a preferred embodiment of the present invention, the inner wrap layer 13 included in the composite layer 14 has a thickness of 0.012-0.024 mm, which is made of polyetherimide (i.e., PI or Kapton) material. The composite layer 14 also contains a glue material 15 with a thickness of 0.01-0.02 mm, and the wrap layer 12 has a thickness of 0.15 mm, which is made of polytetrafluoroethylene with a foaming degree of 65%-77% (the dielectric constant is 2.1 before foaming, and 1.25-1.39 after foaming). The composite layer 14 is made by drawing cable at a rate of 0.1-0.5 m/min and taping with an overlap percentage between 32% and 37% during the wrapping process. The above-mentioned material, thickness, cable-drawing rate, and tape overlap percentage are only the preferred examples of the present invention, and are not intended to limit the present invention.

In such a way, the composite layer of the present invention, such as the composite layer of PTFE material, can achieve higher roundness, higher impedance and lower insertion loss than the prior art using two layers of PTFE. The two layers of PTFE used for comparison here is made of PTFE with a foaming degree of 65%, a cable drawing rate of 0.3 m/min and an overlap percentage of 50% during the wrapping process. Preferably, the embodiment of the present invention can achieve a roundness of 93% or more, while the prior art can only achieve a roundness of 80-85%. Also, the embodiment of the present invention can achieve a differential impedance of 105 ohms, which is higher than 99 ohms of the prior art, and have an insertion loss (I/L) lower than that of the prior art. Preferably, the embodiment of the present invention can achieve the insertion loss of −2.97 dB, while the prior art can only achieve the insertion loss of −3.4 dB.

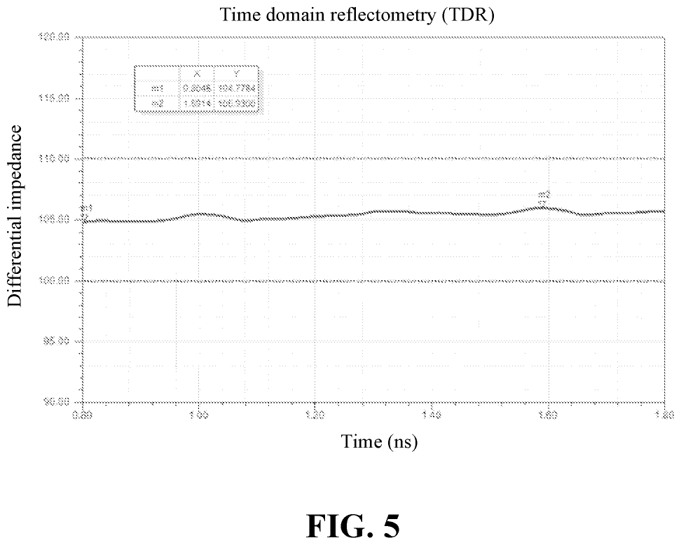

With reference to FIG. 5, FIG. 5 illustrates a curve diagram of a time-domain reflectometry measurement according to an embodiment of the present invention. As shown in FIG. 5, a numerical curve obtained by performing time domain reflectometry (TDR) to a transmission cable made with the above-mentioned preferred values of the present invention contains two points m1 (0.8045, 104.7784) and m2 (1.5914, 105.9300), which fall within the differential impedance range of 100-110 ohm, while the differential impedances of the prior art only fall below 100 ohm.

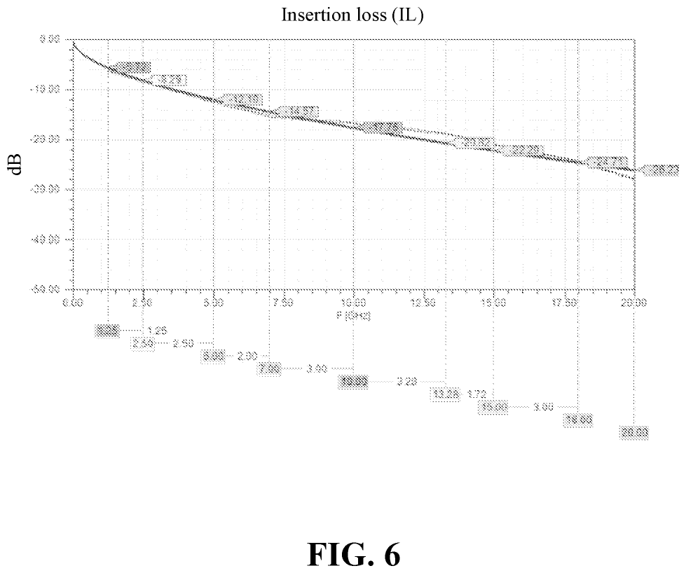

With reference to FIG. 6, FIG. 6 illustrates a curve diagram of an insertion loss measurement according to an embodiment of the present invention. As shown in FIG. 6, the dashed curve represents the values of the insertion loss for the transmission cable made with the above-mentioned preferred values of the present invention, while the solid curve represents the threshold values of the insertion loss. The values for some sections of the curve according to the embodiment of the present invention may be below the threshold values, while the values of the prior art all exceed the threshold values.

The transmission cable according to the present invention can reduce the dielectric constant by covering the inner wrap layer on the conductor before performing the wrapping process. In addition, the alternating wrap manner for the wrap layer can make the transmission cable more compact during the wrapping process, so that the torsion, bending and stretching strength of the transmission cable can be improved, and its insulation and anti-interference effect can also be improved. In such a way, compared with the prior art, the electrical instability and the mechanical strength of the transmission cable of the present invention can be improved, and the insertion loss can be reduced as well.

It is obvious to a person having ordinary knowledge in the technical field that the present invention can be implemented in other specific forms without departing from the spirit of the present invention. Therefore, the above description should not be understood as limiting but illustrative in all respects.

The scope of the present invention should be determined by a reasonable explanation of the scope of the present invention, and all variations within the scope of equivalents of the present invention are included in the scope of the present invention.

What is claimed is:

1. A composite layer for a transmission cable, covering a conductor of the transmission cable and comprising:
an inner wrap layer; and
a wrap layer adhered to the inner wrap layer by a glue material,
wherein the inner wrap layer is used for reducing a dielectric constant, and the wrap layer is used for increasing a bending strength of the transmission cable.

2. The composite layer according to claim 1, wherein the conductor is made of multiple strands.

3. The composite layer according to claim 1, wherein the conductor is made of a metal or an alloy.

4. The composite layer according to claim 1, wherein the inner wrap layer is formed of a foam material.

5. The composite layer according to claim 1, wherein the wrap layer is composed of an insulation material.

6. The composite layer according to claim 1, wherein the inner wrap layer covers the conductor by wrapping.

7. The composite layer according to claim 1, wherein the wrap layer surrounds the inner wrap layer by wrapping.

8. A wrap structure of a transmission cable, comprising:
a conductor; and
a composite layer covering the conductor and including:
an inner wrap layer; and
a wrap layer adhered to the inner wrap layer by a glue material;
wherein the inner wrap layer is used for reducing a dielectric constant, and the wrap layer is used for increasing a bending strength of the transmission cable.

9. The wrap structure according to claim 8, wherein the conductor is made of multiple strands.

10. The wrap structure according to claim 8, wherein the conductor is made of a metal or an alloy.

11. The wrap structure according to claim 8, wherein the inner wrap layer is formed of a foam material.

12. The wrap structure according to claim 8, wherein the wrap layer is composed of an insulation material.

13. The wrap structure according to claim 8, wherein the inner wrap layer covers the conductor by wrapping.

14. The wrap structure according to claim 8, wherein the wrap layer surrounds the inner wrap layer by wrapping.
